(19) United States
(12) Patent Application Publication
(10) Pub. No.: US 2008/0147430 A1
(43) Pub. Date: Jun. 19, 2008

(54) Virtual Event Attendance Systems

(76) Inventor: John D. Hawthorne, Wichita, KS (US)

Correspondence Address: STONEMAN LAW OFFICES, LTD, 3770 NORTH 7RD STREET, Suite 100, PHOENIX, AZ, 85014, US

(21) Appl. No.: 11/958,335

(22) Filed: Dec. 17, 2007

Related U.S. Application Data
(60) Provisional application No. 60/870,571, filed on Dec. 18, 2006.
(60) Provisional application No. 60/915,385, filed on May 1, 2007.

(51) Int. Cl. G06Q 30/00

(52) U.S. Cl. 705/1

(57) ABSTRACT

Virtual attendance at a life event is accomplished by inviting guests to attend the life event, providing an event hall for attendance by a first group of invited guests, and providing remote access to at least one portion of the life event for a second group of invited guests. The remote access preferably includes a bi-directional link providing real-time interaction between the first group and the second group of the invited guests. Management of such a virtual attendance system is preferably accomplished by storing a list of guests invited to remotely attend the life event, registering invited guests on the list, accepting payment from invited guests on the list, and outputting a Uniform Resource Locator (an address of a Web site preferably having at least one real-time video link to the event hall) associated with the life event to the invited guests on the list, only if payment is accepted.

### CROSS-REFERENCE TO RELATED APPLICATION

The present application is related to and claims priority from prior provisional application Ser. No. 60/870,571, filed Dec. 18, 2006, entitled “VIRTUAL EVENT ATTENDANCE SYSTEMS”, and is also related to and claims priority from prior provisional application Ser. No. 60/915,385, filed May 1, 2007, entitled “VIRTUAL EVENT ATTENDANCE SYSTEMS”, the contents both of which are incorporated herein by this reference and are not admitted to be prior art with respect to the present invention by the mention in this cross-reference section.

### BACKGROUND

The present invention relates to virtual event attendance systems. More particularly, it relates to systems for providing remote access to a life event via a communication network.

Some life events, such as weddings and funerals, are so important that people will often travel hundreds or even thousands of miles to attend. However, not everyone who would like to attend a life event will do so. Many people cannot afford to travel long distances. Others can afford the trip but do not have sufficient time to take it. Still others have an impediment to traveling, such as poor health or a disability.

Those who fail to attend an important life event may be left with a feeling that they should have participated in some way. There is often a lingering regret when a life event goes unattended.

Thus, there is a need for efficient systems to assist remote attendance at such life events.

### OBJECTS AND FEATURES OF THE INVENTION

A primary object and feature of the present invention is to assist in solving the above-mentioned problems and in providing the above-mentioned needs. Another primary object and feature of the present invention is to provide remote attendance at a life event for a plurality of invited guests who are unable to attend the life event in person. Still another object and feature of the present invention is to provide virtual event attendance systems that allow for real-time interaction between those in real attendance at the life event and those in virtual/remote attendance.

It is a further object and feature of the present invention to provide a system for managing remote attendance at the life event including storing a list of guests who were invited to remotely attend, registering guests on the list, and accepting payments.

A further primary object and feature of the present invention is to provide identification of a Web site, with an audio/video feed to the life event, to at least one of the invited guests on the list. Another primary object and feature of the present invention is to provide audio/video interaction between guests physically attending the life event and guests viewing the life event remotely.

Other objects and features of this invention will become apparent with reference to the following descriptions.

### SUMMARY OF THE INVENTION

In accordance with a preferred embodiment hereof, this invention provides a computer-based system, relating to managing virtual attendance with regard to at least one life event, such computer-based system comprising: database means for storing at least one list of guests invited to remotely attend the at least one life event; processor means for registering at least one of the invited guests on the at least one list of guests invited to remotely attend the at least one life event; processor means for accepting payment from such at least one of the invited guests on the list of guests invited to remotely attend the life event; and output means for providing at least one identifier associated with the life event to such at least one of the invited guests on the list of guests invited to remotely attend the life event, only if payment is accepted. Moreover, it provides such a computer-based system, wherein the identifier is at least one Uniform Resource Locator for at least one Web site having at least one link to an event hall. Additionally, it provides such a computer-based system, wherein the at least one link is bi-directional. Also, it provides such a computer-based system, wherein such at least one link spans at least one continent. In addition, it provides such a computer-based system, wherein such at least one bi-directional link allows real-time interaction between at least one guest physically situated at the life event and at least one guest provided with the identifier. And, it provides such a computer-based system, further comprising output means for outputting at least one user ID and at least one password. Further, it provides such a computer-based system, wherein the life event is at least one of a funeral, a wedding, a bar mitzvah, a birthday party, a shower, an engagement party, and a graduation party. Even further, it provides such a computer-based system, wherein the at least one link is at least one real-time video link. Moreover, it provides such a computer-based system, wherein the at least one link is bufferable. Additionally, it provides such a computer-based system, wherein remote access to the life event is accomplished by viewing the life event via at least one Web site using at least one multimedia computer.

In accordance with another preferred embodiment hereof, this invention provides a method of managing virtual attendance with regard to at least one life event, the at least one life event held at least one physical location, comprising: storing at least one list of guests invited to remotely attend the at least one life event; registering at least one of the at least one invited guests on the list of guests invited to remotely attend the life event; accepting payment from the at least one registered guest; and providing a Uniform Resource Locator associated with the life event to the at least one registered guest, only if payment from the at least one registered guest is accepted. Also, it provides such a method, wherein the Uniform Resource Locator is for at least one Web site having at least one video link to at least one event hall. In addition, it provides such a method, wherein the at least one video link is bi-directional. And, it provides such a method, wherein the video link spans at least one continent. Further, it provides such a method, wherein the bi-directional video link allows for real-time interaction between at least one guest situated at the physical location and at least one guest provided with the Uniform Resource Locator. Even further, it provides such a method, further comprising outputting at least one of at least one user ID and at least one password. Moreover, it provides such a method, wherein the life event is at least one of a funeral, a wedding, a bar mitzvah, a birthday party, a shower, an engagement party, and a graduation party. Additionally, it provides such a method, wherein the at least one video link is at least one real-time video link. Also, it provides such a method, wherein the at least one video link is bufferable. In addition, it provides such a method, wherein remote access of the life event is accomplished by viewing the at least one life event via at least one Web site using at least one multimedia computer.

In accordance with another preferred embodiment hereof, this invention provides a computer-readable medium which stores a set of instructions which when executed performs a method for managing virtual attendance for at least one life event, the at least one life event physically held in at least one physical location, the method executed by the set of instructions, comprising: storing at least one list of guests invited to remotely attend the at least one life event; registering at least one invited guest on the list of guests invited to remotely attend the at least one life event; accepting payment from at least one registered guest; and providing at least one Uniform Resource Locator associated with the at least one life event to the at least one registered guest, only if payment is accepted from the at least one registered guest. And, it provides such a computer-readable medium, wherein the at least one Uniform Resource Locator is for at least one Web site having at least one video link to the at least one physical location. Further, it provides such a computer-readable medium, wherein the at least one video link is bi-directional. Even further, it provides such a computer-readable medium, wherein the at least one video link spans at least one continent. Moreover, it provides such a computer-readable medium, wherein the bi-directional video link allows real-time interaction between guests situated at the at least one physical location and at least one guest provided with the Uniform Resource Locator. Additionally, it provides such a computer-readable medium, further comprising outputting at least one of a user ID and a password. Also, it provides such a computer-readable medium, wherein the life event is one of a funeral, a wedding, a bar mitzvah, a birthday party, a shower, an engagement party, and a graduation party. In addition, it provides such a computer-readable medium, wherein the at least one video link is a real-time video link. And, it provides such a computer-readable medium, wherein the at least one video link is bufferable. Further, it provides such a computer-readable medium, wherein remote access of the life event is accomplished by viewing the life event via at least one Web site using at least one multimedia computer. In accordance with another preferred embodiment hereof, this invention provides a method, relating to providing virtual attendance to at least one life event, such method comprising the steps of: a) inviting a plurality of guests to attend the at least one life event; b) providing at least one event hall for attendance by a first group of the invited guests; and c) providing remote access to at least one portion of the life event for a second group of the invited guests. Even further, it provides such a method, wherein the step of providing the remote access comprises providing at least one video link, originating at the at least one event hall, to at least one video receiver accessible to the second group of the invited guests. Even further, it provides such a method, wherein the at least one video link is a bi-directional video link. Even further, it provides such a method, wherein the bi-directional video link allows interaction between the first group of the invited guests and the second group of the invited guests. Even further, it provides such a method, wherein the video link includes at least one video camera situated at the at least one event hall. Even further, it provides such a method, wherein the at least one video camera is leased. Even further, it provides such a method, wherein the at least one video camera is provided at no cost. Even further, it provides such a method, wherein the video link spans at least one continent. Even further, it provides such a method, wherein the first group of invited guests is situated in a different country from the second group of invited guests. Even further, it provides such a method, wherein the first group of invited guests is situated in a different state from at least one person in the second group of invited guests. Even further, it provides such a method, wherein the event hall and the remote access are provided by the same entity for a fee. Even further, it provides such a method, wherein the life event is at least one of a funeral, a wedding, a bar mitzvah, a birthday party, a shower, an engagement party, and a graduation party. Even further, it provides such a method, further comprising the step of providing a recorded portion of the at least one life event on at least one physical recording medium. Even further, it provides such a method, wherein the recorded portion of the at least one life event is edited. Even further, it provides such a method, wherein remote access of the at least one life event is accomplished by viewing the life event via at least one Web site using at least one multimedia computer. Even further, it provides such a method, wherein the at least one Web site requires access by at least one authorized user.

It also provides each and every novel feature, element, combination, step and/or method disclosed or suggested by this patent application.

### BRIEF DESCRIPTION OF THE DRAWINGS

FIG. 1 shows diagrammatically an Event Site according to a preferred embodiment of the present invention.

FIG. 2 shows a diagram of several preferred embodiments of Viewing Sites for remote participation in a life event according to the present invention.

FIG. 3 shows a block diagram of a Virtual Event Attendance Management System according to a preferred embodiment of the present invention.

FIG. 4 shows a database structure for storing registration information according to a preferred embodiment of the present invention.

FIG. 5 shows a listing of registered guests according to a preferred embodiment of the present invention.

FIG. 6 shows an email invitation to a life event according to a preferred embodiment of the present invention.

FIG. 7 shows a diagrammatic overview illustrating providing bi-directional communication via a bi-directional communication link according to a preferred embodiment of the present invention.

### DETAILED DESCRIPTION OF THE BEST MODES AND PREFERRED EMBODIMENTS OF THE INVENTION

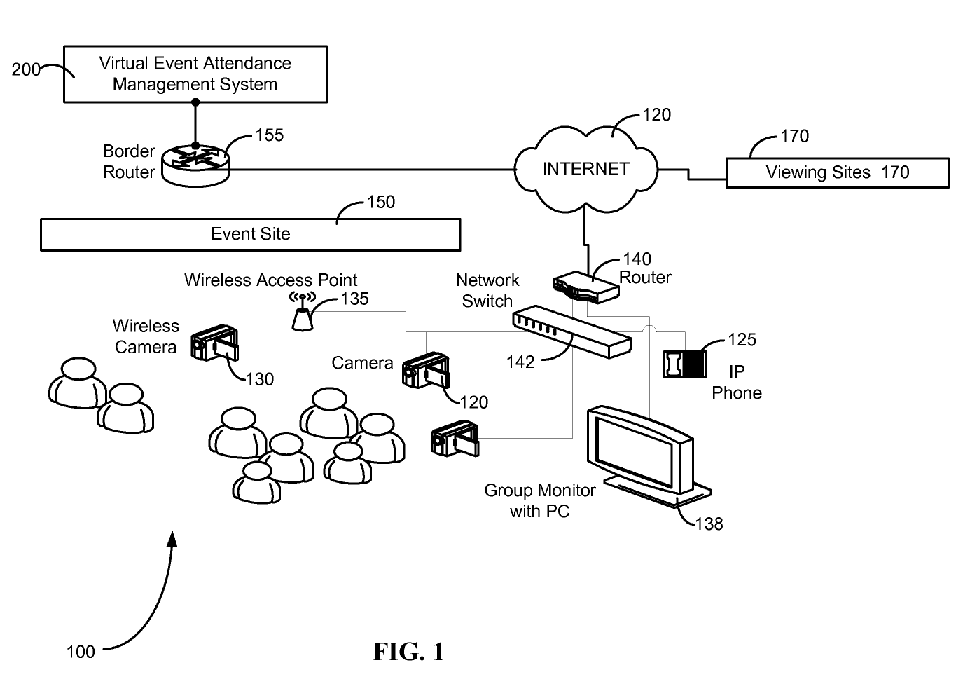

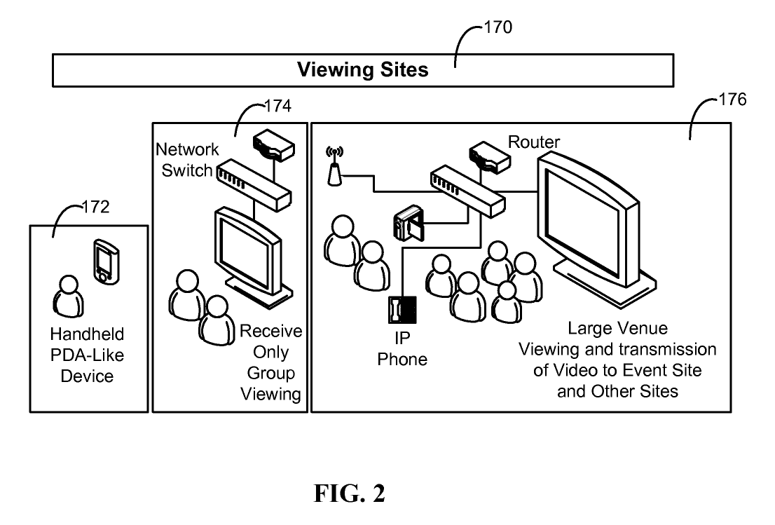

FIG. 1 shows diagrammatically an Event Site according to a preferred embodiment of the present invention. FIG. 1 depicts Event Site 150, preferably including an event hall or other physical location for holding a life event, according to a preferred embodiment of the present invention, identified herein as Virtual Event Attendance System 100. In general, a “life event” is any event in which people gather regarding an important occurrence in someone's life, such as, for example, a funeral, a wedding, a bar mitzvah, a birthday party, a shower, an engagement party, a graduation party, etc. Preferably, Event Site 150 will be large enough to accommodate a plurality of guests 110 who were invited to attend the life event. In addition to these guests 110 who are physically situated at Event Site 150, preferably at least one remote guest 115 will be able to participate in the life event remotely via communication link at Viewing Sites 170 (shown in FIG. 2). In a highly preferred embodiment, Virtual Event Attendance System 100 comprises a bi-directional link wherein remote guest 115 may communicate with guest 100 physically situated at Event Site. Preferably, Virtual Event Attendance Management System 200 is linked to router 140 via Internet 120. Preferably, to provide security, border router 155 is provided between Internet 120 and Virtual Event Attendance Management System 200.

Preferably, Event Site 150 will include at least one wired video camera 120 and/or wireless video camera 130, as shown. Preferably, video cameras 120, 130 will be installed and bracketed (if necessary) at appropriate places in an event hall or other location to capture the life event. As shown, Event Site 150 preferably also includes a group monitor with PC 138 that preferably will comprise a personal computer with multimedia capabilities and equipped with microphone and speakers. Preferred such personal computers are personal computers equipped with microphone and speakers in the DIMENSION™, OPTIPLEX™, and PRECISION™ lines of computers by Dell, Inc., of Round Rock, Tex. Preferably, the group monitor with PC 138 preferably provides guests 110 physically present at Event Site 150 with the ability to interact with remote guests 115. For example, if the life event is a funeral, then remote guests 115 might offer their condolences to guests 110 who are physically present at Event Site 150. Alternatively, or in addition, guests 110 physically present at Event Site 150 preferably would be able to interact with remote guests 115 via telephone 125. Preferably, telephone 125 used for this purpose will be an IP (Internet Protocol) Phone utilizing a Voice Over IP (“VoIP”) protocol. Under appropriate circumstances, conventional telephones or cellular telephones may suffice. (Such above-described arrangement (telephone 125, video cameras 120, 130, router 140, network switch 142, etc.) at least embodying herein at least one bi-directional link provides real-time communication with guests at the event site and remote guests).

Preferably, Event Site 150 will include a network switch 142 capable of transparently bridging data from various devices to form a network, as shown. Network switch 142 will preferably be connected to router 140, as shown. Preferably, router 140 will be connected to Internet 120, as shown. Preferably, Event Site 150 will include a wireless infrastructure to support at least one wireless device, such as wireless video camera 130, as shown. Preferably, this wireless infrastructure will include at least one wireless access point (“WAP”) 135, as shown. Preferably, WAP 135 will connect and relay data to network switch 142, as shown. Preferably, wired video cameras 120 will be connected and relay data to the network switch 142, as shown. Preferably, the Group Monitor with PC 138 and the IP telephone 125 will be connected and relay data to and from the network switch 142, as shown.

Upon reading the teachings of this specification, those of ordinary skill in the art will now understand that, under appropriate circumstances, considering such issues as intended use, cost, availability, user preference, etc., other network configurations, such as any combination of wide area networks, local area networks, public switched telephone networks, wireless or wired networks, intranets, or any other distributed processing network or system, etc., may suffice.

FIG. 2 shows a diagram of several preferred embodiments of Viewing Sites for remote participation in a life event according to the present invention. As shown in the first preferred embodiment, in Viewing Site 172, individual remote guest 115 preferably will access the life event using a handheld computing device, preferably a personal digital assistant (“PDA”) or a WAP-compatible telephone. Preferred PDA's include the BLACKBERRY™ line of PDA's by Research In Motion, Ltd., of Ontario, Canada and the PALM PILOT™ by Palm, Inc., of Santa Barbara, Calif. Preferred WAP-compatible telephones include the Nokia™ 3200 mobile handset. Using the handheld computing device, remote guest 115 will preferably be able to view the life event as a streaming video or streaming media presentation. The handheld computing device will preferably be connected to Internet 120 (via an Internet Service Provider) and have a suitable software program installed for viewing the streaming video.

As shown in an alternate (second) preferred embodiment, in Viewing Site 174, a plurality of remote guests 115 may preferably view the life event preferably via a personal computer with multimedia capabilities and equipped with microphone and speakers. Preferred such personal computers are personal computers equipped with microphone and speakers in the DIMENSION, OPTIPLEX and PRECISION lines of computers by Dell, Inc., of Round Rock, Tex. In this configuration, the personal computer would preferably have appropriate software to view a streaming video or streaming media presentation of the life event. Preferred suitable software is the REALPLAYER by RealNetworks, Inc., of Seattle, Wash. The personal computer will preferably be connected to Internet 120 (via an Internet Service Provider).

As shown in an alternate (third) preferred embodiment, in Viewing Site 176, a plurality of remote guests 115 are preferably able to interact with guests 110 physically at Event Site 150. Preferably, in this configuration, one or more video cameras, such as wireless video camera 130, is employed at the Viewing Site 176 to capture audio/video of remote guests 115. Remote guests 115 are preferably able to view and hear guests 110 who are physically present at Event Site 150 via a personal computer at the Viewing Site 176 that is equipped with monitor and speakers. Preferred such personal computers are personal computers equipped with monitor and speakers in the DIMENSION, OPTIPLEX and PRECISION lines of computers by Dell, Inc., of Round Rock, Tex. Preferably, remote guests 115 will also be able to communicate with guests 110 using an IP telephone (or other type of telephone). Preferably, the video cameras, personal computer and IP phone are connected to a network switch, which, in turn, is connected to a router, as shown. The router is preferably connected to Internet 120, as shown. If wireless devices are used, each of these devices will preferably be connected to a wireless access point (“WAP”) which will preferably be connected to the network switch.

Upon reading the teachings of this specification, those of ordinary skill in the art will now understand that, under appropriate circumstances, considering such issues as intended use, cost, availability, user preference, etc., other viewing site arrangements may suffice.

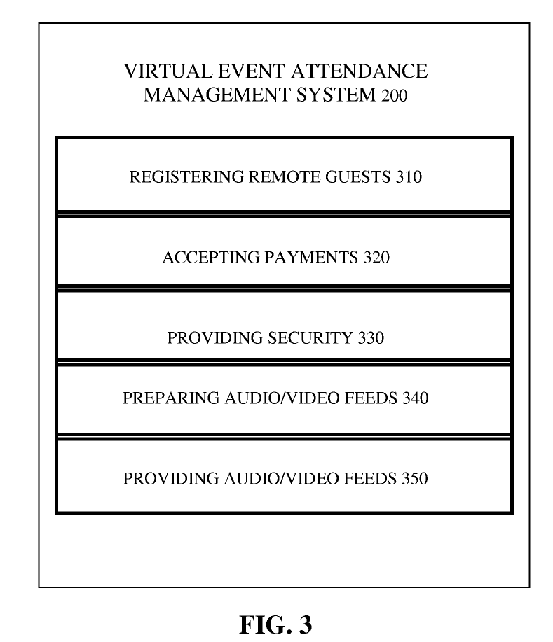

FIG. 3 shows a block diagram of a Virtual Event Attendance Management System 200 according to a preferred embodiment of the present invention. Virtual Event Attendance Management System 200 preferably provides the tasks necessary for the following preferred steps: (1) Registering remote guests 310, (2) Accepting payments 320, (3) Providing security 330, (4) Preparing audio/video feeds 340, and (5) Providing audio/video feeds 350. With continued reference to FIG. 3, the following discussion describes each of these preferred steps:

(1) Registering Remote Guests 310

Preferably, Virtual Event Attendance Management System 200 described herein will be operated by a third party service provider. Preferably, organizers of the life event will contract with this service provider, preferably for a fee and will preferably provide information regarding the life event. Preferably, registration information will be stored in a relational database and preferably organized into tables.

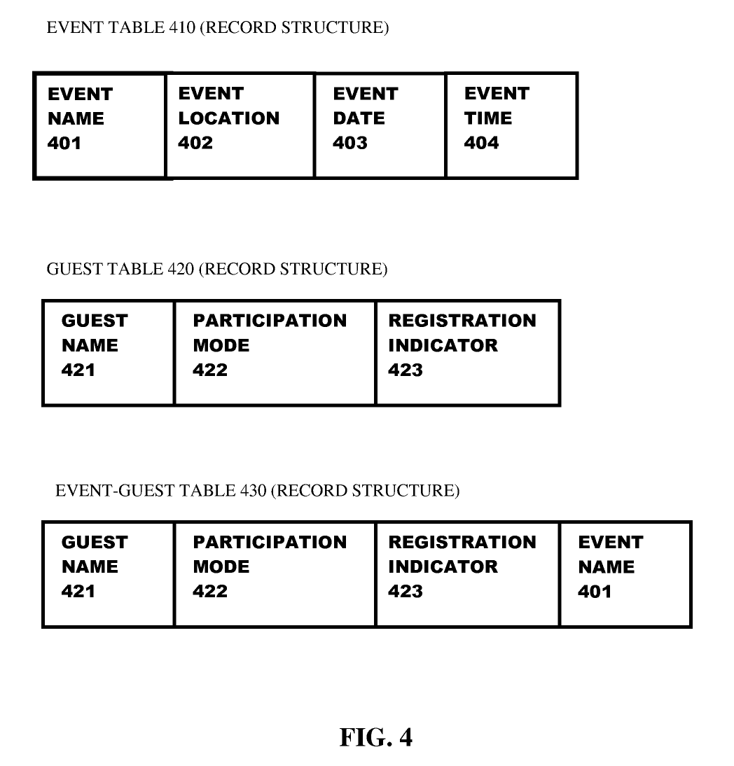

FIG. 4 shows a database structure for storing registration information according to a preferred embodiment of the present invention. As shown, Event Table 410 preferably includes Event Name 401, Event Location 402, Event Date 403, and Event Time 404. Guest Table 420 preferably includes Guest Name 421, Participation Mode 422, Registration Indicator 423, and Event Name 401. Event-Guest Table 430 shows Event Table 410 and Guest Table 420 being preferably joined.

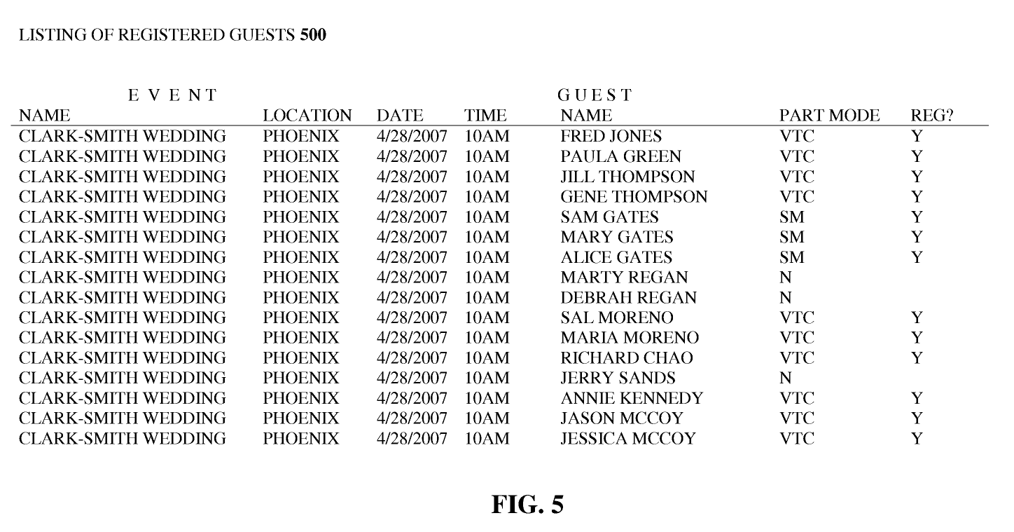

FIG. 5 shows a listing of registered guests 500 according to a preferred embodiment of the present invention.

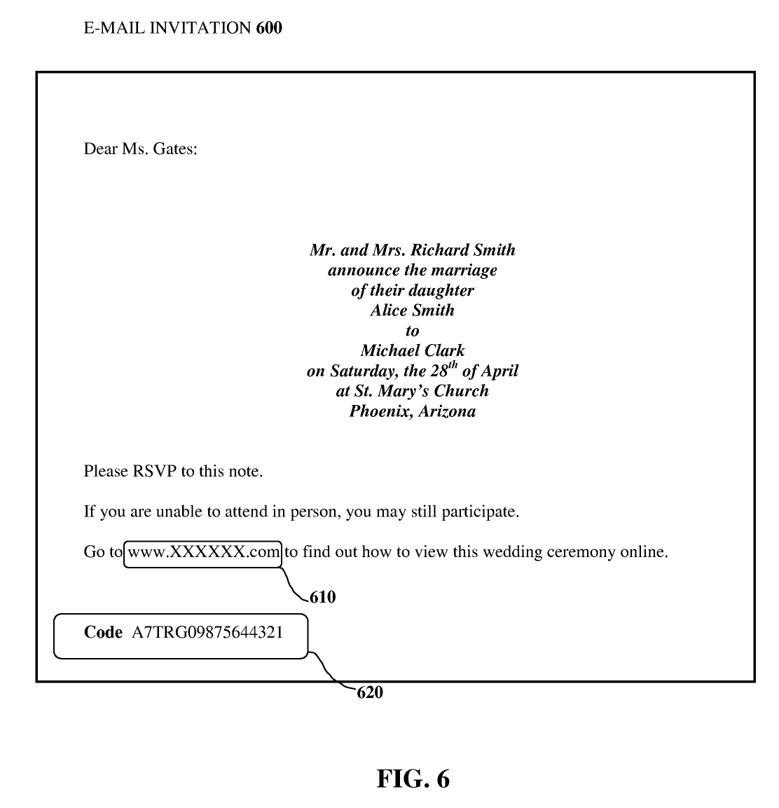

FIG. 6 shows an email invitation to a life event according to a preferred embodiment of the present invention. Preferably, paper invitations will be sent to all invitees, preferably along with information as to how an invitee might register for remote attendance. Alternatively, or in addition, invitations for remote participation will preferably be sent electronically. A preferred electronically sent invitation is email invitation 600, shown in FIG. 6. Preferably, any invitations (paper or email) will provide the Uniform Resource Locator (“URL”) of Web site 610 operated by the service provider, preferably along with code 620 to be used to register for remote attendance at the life event. Preferably, this Web site will require that the user provide code 620 and preferably a unique identifier such as their email address. Preferably, this Web site will require that the user provide a password. Together, code 620, the unique identifier, and the password will preferably serve to authenticate the user and to allow him or her to register for the appropriate life event. Preferably, other functions related to registration, such as, for example, sending an RSVP, adding or deleting significant others who will also remotely attend, etc., will be available during registration.

(2) Accepting Payments 320

Preferably, when a person registers to remotely participate in a life event, it will be the case that payment will then be required. Preferably, the payment will be made by major credit card (such as, for example, Visa Card, Master Card, American Express Card, Discover Card), debit card, electronic check, or gift card. Preferably, the service provider will have a merchant account and necessary software to allow payments to be processed. An example of such software is the X-CHARGE™ payment processing software by X-Charge, Inc., of Fountain Valley, Calif. which supports each of the above-mentioned payment modes.

Preferably, once a person has paid for remote attendance at the life event, the appropriate database records will be updated with an indication that the person is now a registered guest. (Preferably, Registration Indicator 423 will be set to “Y”.) Preferably, when the deadline for registration has passed, the Web site will no longer allow anyone else to register for the life event. Thereafter, an email note with a list of registered remote guests will preferably be sent to the organizers of the life event. Preferably, such a list will be generated by selecting all registered guests associated with the life event who have a “Y” in the field containing Registration Indicator 423.

(3) Providing Security 330

Preferably, throughout the entire process described herein, security will be provided at varying levels of stringency. Preferably, tightest security will be provided to protect the hardware and software associated with the functions of Registering Remote Guest 310 and Accepting Payments 320 (e.g., the database server, application server, commerce server, backup server, and network connections associated with these functions). Preferably a Layer 4 Firewall will be installed to provide such tight security. Preferably, moderate security will be provided to protect the hardware and software associated with the functions of Preparing Video Feeds 340 and Providing Video Feeds 350 (e.g., the web servers, telephony servers, email and instant messaging servers, and streaming media servers associated with these functions). Preferably, a Layer 3 Firewall will be installed to provide such moderate security. Preferably, minimal security will be provided at Event Site 150 and the Viewing Sites 170 since these will be restricted to guests and authorized personnel.

(4) Preparing Audio/Video Feeds 340

Preferably, there will be two types of audio/video feeds used herein: (1) a video-teleconferencing (“VTC”) feed and (2) a streaming media (“SM”) feed. Preferably, the VTC feed will be used whenever real-time interaction between guests 110 physically present at Event Site 150 and remote guests 115 is desired. For example, in Viewing Site 176, a plurality of remote guests 115 are preferably able to interact with guests 110 present physically at Event Site 150. Preferably, in this configuration, one or more video cameras, such as wireless video camera 130, may be employed at the Viewing Site 176 to capture audio/video of remote guests 115. Remote guests 115 are preferably able to communicate with guests 110 who are physically present at Event Site 150 via a personal computer at the Viewing Site 176 that is equipped with monitor and speakers. Preferably, suitable VTC software will be installed on each personal computer. Preferably, such VTC software will provide echo cancellation and a decentralized multipoint (preferably, according to the H.323 standard promulgated by the International Telecommunications Union (“ITU”)). Preferably, an SM feed will be provided when real-time interaction is not needed or desired. For example, in Viewing Sites 172, 174, one or more remote guest employs a computing device to play a streaming media of the life event. Streaming media is a sequence of images that are sent via Internet 120 in compressed format. As portions of the stream arrive, they are buffered and played on a “player” that decompresses the data and sends the video portion to the monitor and the audio portion to the speakers. Preferably, the media stream is prepared using a streaming server. Preferably, the content to be played from the streaming server is prepared using a suitable software package designed for this purpose, such as, for example, the REALPRODUCER by RealNetworks, Inc., of Seattle, Wash. or using WINDOWS MEDIA TECHNOLOGY by Microsoft Corporation of Redmond, Wash.

Upon reading the teachings of this specification, those of ordinary skill in the art will now understand that, under appropriate circumstances, considering such issues as intended use, cost, availability, user preference, etc., dedicated communication devices for video-teleconferencing may suffice.

(5) Providing Audio/Video Feeds 350

Preferably, once remote guest 115 has registered to remotely attend the life event, remote guest 115 will be assigned a mode of participation in the life event. For example, those guests who plan to view the life event as a streaming media presentation will be registered as “SM” mode guests. And those guests who desire real-time interaction will be registered as “VTC” mode guests. Preferably, upon registration, the registered guest will be provided with a full set of instructions regarding how to log on and access the life event. Preferably, the remote guests will use the same user id and password to access the event. Preferably, an email note will be sent to each of the registered guests with information as to the date and time of the life event, and instructions on how to access the life event using a computer or PDA, as may be the case. Preferably, the email note will also provide instructions regarding downloading any software, such as software needed to play streaming media. Preferably, registered guests who wish to congregate in a remote viewing site with other remote guests will be provided with the address of the remote viewing site along with directions and a map of the viewing site.

After the life event ends, all guests (both guests 110 physically situated at Event Site 120 and remote guests 115) will be offered recorded audio/video of the life event on a suitable recording medium, such as, for example, on a CD-ROM or DVD. Preferably, the recorded audio/video of the life event will be edited to highlight key parts of the life event, such as, for example, when the wedding cake is cut at the end of the wedding ceremony.

As mentioned, preferably, Virtual Event Attendance Management System 200 will be provided by service provider 700, who may preferably be a third party, as shown. Preferably, service provider 700 will have available for lease or purchase (and, in some cases, for free usage) various audio/video equipment and any other equipment that may be used. Preferably, the service provider will also provide services to set up and take down equipment, and to provide other assistance. Preferably, the service provider will enter into advantageous business arrangements with computer hardware and/or software companies to obtain equipment at discounted prices. Preferably, the service provider will provide the ability to remotely participate in life events that are physically situated in a different state or country from where at least one remote guest is situated. Preferably, the audio/video link will be able to accommodate communication over geographic boundaries (e.g., between states or countries) and include satellite communication when necessary, such as when communication is across continents (e.g., from India to the United States).

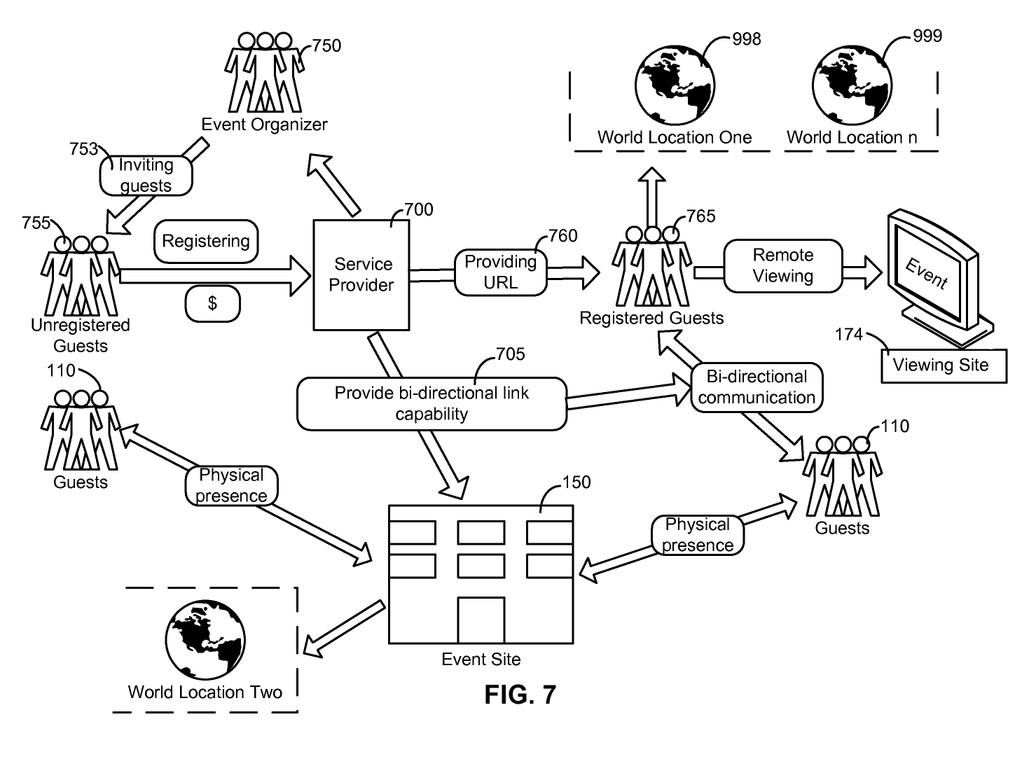

FIG. 7 shows a diagrammatic overview illustrating providing bi-directional communication via a bi-directional communication link according to a preferred embodiment of the present invention. Preferably, event organizer 750 invites unregistered guests 755 in preferred step 753, as shown and as described above. Unregistered guests 755 who register and pay a fee to service provider 700 will be provided with a URL for remote viewing in preferred step 760, as shown. Preferably, service provider 700 provides Event Site 150 with bi-directional link capability in preferred step 705, as shown. Preferably, bi-directional link provides real-time communication ability. At remote viewing site 174, remote guest 115 (now registered guests 765) may communicate with guest 110 via service provider 700 provided bi-directional link capability, as shown. Such a system makes it possible for remote guests 115 situated at World Location One 998 (or at a plurality of World Locations illustrated by World Location n 999) to communicate with those at Event Site 150 situated at World Location Two 997, as shown. Such world locations may preferably be different states, different continents, different islands, different countries, and the like.

Although applicant has described applicant's preferred embodiments of this invention, it will be understood that the broadest scope of this invention includes modifications. Such scope is limited only by the below claims as read in connection with the above specification. Further, many other advantages of applicant's invention will be apparent to those skilled in the art from the above descriptions and the below claims.

What is claimed is:

1) A computer-based system, relating to managing virtual attendance with regard to at least one life event, said computer-based system comprising:
a) database means for storing at least one list of guests invited to remotely attend the at least one life event;
b) processor means for registering at least one of the invited guests on the at least one list of guests invited to remotely attend the at least one life event;
c) processor means for accepting payment from such at least one of the invited guests on the list of guests invited to remotely attend the life event; and
d) output means for providing at least one identifier associated with the life event to such at least one of the invited guests on the list of guests invited to remotely attend the life event, only if payment is accepted.

2) The computer-based system, according to claim 1, wherein the identifier is at least one Uniform Resource Locator for at least one Web site having at least one link to an event hall.

3) The computer-based system, according to claim 2, wherein the at least one link is bi-directional.

4) The computer-based system, according to claim 2, wherein such at least one link spans at least one continent.

5) The computer-based system, according to claim 3, wherein such at least one bi-directional link allows real-time interaction between at least one guest physically situated at the life event and at least one guest provided with the identifier.

6) The computer-based system, according to claim 1, further comprising output means for outputting at least one user ID and at least one password.

7) The computer-based system, according to claim 1, wherein the life event is at least one of a funeral, a wedding, a bar mitzvah, a birthday party, a shower, an engagement party, and a graduation party.

8) The computer-based system, according to claim 2, wherein the at least one link is at least one real-time video link.

9) The computer-based system, according to claim 2, wherein the at least one link is bufferable.

10) The computer-based system, according to claim 1, wherein remote access to the life event is accomplished by viewing the life event via at least one Web site using at least one multimedia computer.

11) A method of managing virtual attendance with regard to at least one life event, the at least one life event held at least one physical location, comprising:
a) storing at least one list of guests invited to remotely attend the at least one life event;
b) registering at least one of the at least one invited guests on the list of guests invited to remotely attend the life event;
c) accepting payment from the at least one registered guest; and
d) providing a Uniform Resource Locator associated with the life event to the at least one registered guest, only if payment from the at least one registered guest is accepted.

12) The method, according to claim 11, wherein the Uniform Resource Locator is for at least one Web site having at least one video link to at least one event hall.

13) The method, according to claim 12, wherein the at least one video link is bi-directional.

14) The method, according to claim 12, wherein the video link spans at least one continent.

15) The method, according to claim 13, wherein the bi-directional video link allows for real-time interaction between at least one guest situated at the physical location and at least one guest provided with the Uniform Resource Locator.

16) The method, according to claim 11, further comprising outputting at least one of at least one user ID and at least one password.

17) The method, according to claim 11, wherein the life event is at least one of a funeral, a wedding, a bar mitzvah, a birthday party, a shower, an engagement party, and a graduation party.

18) The method, according to claim 12, wherein the at least one video link is at least one real-time video link.

19) The method, according to claim 12, wherein the at least one video link is bufferable.

20) The method, according to claim 11, wherein remote access of the life event is accomplished by viewing the at least one life event via at least one Web site using at least one multimedia computer.

21) A computer-readable medium which stores a set of instructions which when executed performs a method for managing virtual attendance for at least one life event, the at least one life event physically held in at least one physical location, the method executed by the set of instructions, comprising:
a) storing at least one list of guests invited to remotely attend the at least one life event;
b) registering at least one invited guest on the list of guests invited to remotely attend the at least one life event;
c) accepting payment from at least one registered guest; and
d) providing at least one Uniform Resource Locator associated with the at least one life event to the at least one registered guest, only if payment is accepted from the at least one registered guest.

22) The computer-readable medium, according to claim 21, wherein the at least one Uniform Resource Locator is for at least one Web site having at least one video link to the at least one physical location.

23) The computer-readable medium, according to claim 22, wherein the at least one video link is bi-directional.

24) The computer-readable medium, according to claim 22, wherein the at least one video link spans at least one continent.

25) The computer-readable medium, according to claim 23, wherein the bi-directional video link allows real-time interaction between guests situated at the at least one physical location and at least one guest provided with the Uniform Resource Locator.

26) The computer-readable medium, according to claim 21, further comprising outputting at least one of a user ID and a password.

27) The computer-readable medium, according to claim 21, wherein the life event is one of a funeral, a wedding, a bar mitzvah, a birthday party, a shower, an engagement party, and a graduation party.

28) The computer-readable medium, according to claim 22, wherein the at least one video link is a real-time video link.

29) The computer-readable medium, according to claim 22, wherein the at least one video link is bufferable.

30) The computer-readable medium, according to claim 21, wherein remote access of the life event is accomplished by viewing the life event via at least one Web site using at least one multimedia computer.

31) A method, relating to providing virtual attendance to at least one life event, said method comprising the steps of:
a) inviting a plurality of guests to attend the at least one life event;
b) providing at least one event hall for attendance by a first group of the invited guests; and
c) providing remote access to at least one portion of the life event for a second group of the invited guests.

32) The method, according to claim 31, wherein the step of providing the remote access comprises providing at least one video link, originating at the at least one event hall, to at least one video receiver accessible to the second group of the invited guests.

33) The method, according to claim 32, wherein the at least one video link is a bi-directional video link.

34) The method, according to claim 33, wherein the bi-directional video link allows interaction between the first group of the invited guests and the second group of the invited guests.

35) The method, according to claim 33, wherein the video link includes at least one video camera situated at the at least one event hall.

36) The method, according to claim 35, wherein the at least one video camera is leased.

37) The method, according to claim 35, wherein the at least one video camera is provided at no cost.

38) The method, according to claim 32, wherein the video link spans at least one continent.

39) The method, according to claim 31, wherein the first group of invited guests is situated in a different country from the second group of invited guests.

40) The method, according to claim 31, wherein the first group of invited guests is situated in a different state from at least one person in the second group of invited guests.

41) The method, according to claim 31, wherein the event hall and the remote access are provided by the same entity for a fee.

42) The method, according to claim 31, wherein the life event is at least one of a funeral, a wedding, a bar mitzvah, a birthday party, a shower, an engagement party, and a graduation party.

43) The method, according to claim 31, further comprising the step of providing a recorded portion of the at least one life event on at least one physical recording medium.

44) The method, according to claim 43, wherein the recorded portion of the at least one life event is edited.

45) The method, according to claim 31, wherein remote access of the at least one life event is accomplished by viewing the life event via at least one Web site using at least one multimedia computer.

46) The method, according to claim 45, wherein the at least one Web site requires access by at least one authorized user.
